(19) United States
(12) Patent Application Publication
(10) Pub. No.: US 2013/0188257 A1
(43) Pub. Date: Jul. 25, 2013

(54) MICRO LENS, DEVICE EMPLOYING THE SAME, AND METHOD OF MANUFACTURING THE SAME

(71) Applicants: Seong-ho Cho, Gwacheon-si (KR); Young-soo Park, Yongin-si (KR)

(72) Inventors: Seong-ho Cho, Gwacheon-si (KR); Young-soo Park, Yongin-si (KR)

(73) Assignee: SAMSUNG ELECTRONICS CO., LTD., Suwon-si (KR)

(21) Appl. No.: 13/550,766

(22) Filed: Jul. 17, 2012

(30) Foreign Application Priority Data
Jan. 20, 2012 (KR) 1020120006807

(51) Int. Cl. G02B 27/12

(52) U.S. Cl. 359/627

(57) ABSTRACT

Example embodiments relate to a micro lens and a method of manufacturing the micro lens. The micro lens may include a substrate and an internal lens region existing in the substrate. The internal lens region may have a refractive index that is different from a refractive index of the substrate. The internal lens region may include at least one boundary contacting the substrate and formed as a curve. As a result, light incident in the substrate through a surface of the substrate is converged or diverged by the curve.

### CROSS-REFERENCE TO RELATED APPLICATION

This application claims priority under 35 U.S.C. §119 to Korean Patent Application No. 10-2012-0006807, filed on Jan. 20, 2012 in the Korean Intellectual Property Office, the disclosure of which is incorporated herein in its entirety by reference.

### BACKGROUND

1. Field

The present disclosure relates to micro lenses, devices including the micro lenses, and methods of manufacturing the micro lenses, and more particularly, to micro lenses capable of condensing/dispersing light relatively easily in a substrate and improving a photo-coupling efficiency, devices including the micro lens, and methods of manufacturing the micro lenses.

2. Description of the Related Art

Semiconductor integrated circuits are formed on a printed circuit board, and electrically transmit/receive data through metal wires. In data transmission, the electrical connection using the metal wires has a relatively high power consumption due to higher transmission loss in a radio frequency area, and it is relatively difficult to design a data transmission system due to electromagnetic interference (EMI). On the other hand, an optical interconnect technology for transmitting/receiving data through light beams has less transmission loss and less EMI compared to the electrical connection, thereby realizing a wider bandwidth data transmission system of higher transmission speed.

The optical interconnect technology has been actively researched recently as a method of transmitting/receiving data in a local area and a relatively short-range. Currently, the optical interconnect technology for transmitting/receiving data optically has been developed on stages of system-to-system, module-to-module, package-to-package, chip-to-chip, and on-chip.

In order to realize a local area and a relatively short-range optical interconnect system such as chip-to-chip or on-chip, research on a photonic integrated circuit that integrates various optical devices such as a light source, an optical waveguide, an optical modulator, an optical filter, and a photodetector has been actively conducted. When electric signals exchanged between devices are replaced with optical signals, interference of external electromagnetic waves may be reduced and higher speed communication may be achieved.

In the optical interconnect technology, various researches for improving a photo-coupling efficiency so as to reduce optical loss are being conducted.

Improvement of the photo-coupling efficiency is an important matter in other optical technologies based on silicon, for example, in a field of an image sensor, as well as in the optical interconnect technology.

As well known in the art, an image sensor is being required in various fields such as a high density image sensor that may be used in a camera having relatively high definition and an image sensor that is sensitive to ultraviolet rays/infrared rays and used in a touch panel. A representative image sensor that is currently commercialized is, for example, a charged coupled device (CCD) image sensor and a complementary metal oxide semiconductor (CMOS) image sensor. The CCD and the CMOS image sensor have a PN junction formed of a semiconductor such as silicon as a basic structure.

In the above image sensor, when the number of pixels increases according to demands for higher definition and a size of a unit cell for sensing a color is reduced, a relative area of a region for sensing light in each of the pixels (that is, an aperture ratio) is reduced, and thus a light usage efficiency may degrade. Therefore, it is important to improve the photo-coupling efficiency in an image sensor for relatively high definition.

### SUMMARY

Example embodiments relate to micro lenses capable of condensing/dispersing light in a substrate relatively easily and improving a photo-coupling efficiency in various optical technology fields, devices adopting the micro lenses, and methods of manufacturing the micro lenses.

A micro lens may include a substrate and an internal lens region existing in the substrate. The internal lens region may have a first refractive index that is different from a second refractive index of the substrate. The internal lens region may include at least one boundary contacting the substrate. The at least one boundary may have a form of a curve. The micro lens may be configured such that light incident in the substrate through a surface of the substrate is converged or diverged by the curve.

The substrate may have at least one flat surface.

The substrate and internal lens region may include the same base material. Additionally, one of the substrate and internal lens region may include an element not present in the other of the substrate and internal lens region. The element may be oxygen. Furthermore, the internal lens region may have a meniscus shape, a partial ellipsoidal shape, or a partial spherical shape.

The internal lens region may have a refractive index that is less than the refractive index of the substrate.

The substrate may include silicon, and the internal lens region may include silicon oxide.

The internal lens region may be formed in the substrate by an ion implantation.

The substrate may have a refractive index less than the refractive index of the internal lens region.

The substrate may include silicon oxide, and the internal lens region may include silicon.

The substrate may be obtained by performing an ion implantation of a region except for the internal lens region in a silicon layer.

The substrate may be obtained by performing an ion implantation of a region except for the internal lens region in a layer formed of a material forming the internal lens region.

The substrate may be a semiconductor substrate. In a non-limiting embodiment, the substrate may be a silicon substrate.

An optical apparatus may include the micro lens; and an optical device for receiving light that is converged or diverged by the micro lens.

The micro lens may be formed of a silicon material.

The optical device may be one selected from the group consisting of a photodetector, an image sensor, an optical fiber, and an optical waveguide for an optical integration circuit.

A method of forming a micro lens may include preparing a substrate and performing an ion implantation on the substrate to define an internal lens region and a substrate region in the substrate such that only one of the internal lens region and the substrate region is subjected to the ion implantation to form an ion-implanted region. The internal lens region may have a first refractive index and the substrate may have a different second refractive index as a result of the ion implantation. At least one boundary between the substrate region and the internal lens region may be in a form of a curve.

The internal lens region may be ion-implanted so as to have a refractive index that is less than a refractive index of a remaining substrate region.

A region of the substrate other than the internal lens region may be ion-implanted, and the remaining substrate region may have a refractive index that is less than a refractive index of the internal lens region.

The substrate may include silicon.

The ion-implanted region of the substrate may include silicon oxide.

### BRIEF DESCRIPTION OF THE DRAWINGS

These and/or other aspects will become more apparent and more readily appreciated from the following description, taken in conjunction with the accompanying drawings of which:

FIG. 1 is a schematic diagram of a micro lens according to example embodiments;

FIG. 2A is a diagram showing an optical path in a case where a flat plate type micro lens of FIG. 1 functions as a concave lens for diverging incident parallel light due to a refractive index of an inner lens region being less than that of a remaining substrate region;

FIG. 2B is a diagram showing an optical path in a case where the flat plate type micro lens of FIG. 1 functions as a convex lens for converging incident parallel light due to the refractive index of the inner lens region being greater than that of the remaining substrate region;

FIG. 3 is a diagram of another micro lens according to example embodiments;

FIG. 4A is a diagram showing an optical path in a case where the micro lens of FIG. 3 functions as a convex lens for converging incident parallel light due to a refractive index of an inner lens region being less than that of a remaining substrate region;

FIG. 4B is a diagram showing an optical path in a case where the micro lens of FIG. 3 functions as a concave lens for diverging incident parallel light due to the refractive index of the inner lens region being greater than that of the remaining substrate region;

FIG. 5 is a schematic diagram of another micro lens according to example embodiments;

FIG. 6A is a diagram showing an optical path in a case where the micro lens of FIG. 5 functions as a concave lens for diverging incident parallel light due to a refractive index of an inner lens region being less than that of a remaining substrate region;

FIG. 6B is a diagram showing an optical path in a case where the micro lens of FIG. 5 functions as a convex lens for converging incident parallel light due to the refractive index of the inner lens region being greater than that of the remaining substrate region;

FIGS. 7A through 7G are diagrams illustrating a method of manufacturing a micro lens according to example embodiments;

FIGS. 8A through 8C are diagrams illustrating another method of manufacturing a micro lens according to example embodiments;

FIGS. 9A through 9D are diagrams showing processes of manufacturing a micro lens having an inner lens region that includes a concave curved surface at a light incident side;

FIGS. 10A through 10C are diagrams showing examples of a mask structure that may be used to form a vertical lens structure shown in FIG. 6A;

FIG. 11 is a diagram showing a shape of an inner lens region when the vertical lens structure shown in FIG. 6A is formed by using a mask shown in FIGS. 10A through 10C while differentiating implantation energy;

FIGS. 12A through 12C are diagrams showing examples of a mask structure that may be used to form a vertical lens structure shown in FIG. 6B; and

FIG. 13 is a diagram showing a shape of an inner lens region when the vertical lens structure shown in FIG. 6B is formed by using a mask shown in FIGS. 12A through 12C while differentiating implantation energy.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Reference will now be made in more detail to various non-limiting embodiments, examples of which are illustrated in the accompanying drawings, wherein like reference numerals refer to like elements throughout. In the drawings, the thicknesses of layers and regions may have been exaggerated for clarity. Throughout the detailed description and claims, a substrate may denote a substrate itself on which a micro lens is formed, for example, a semiconductor substrate, or may include a substrate and a material layer on the substrate in which a micro lens is formed.

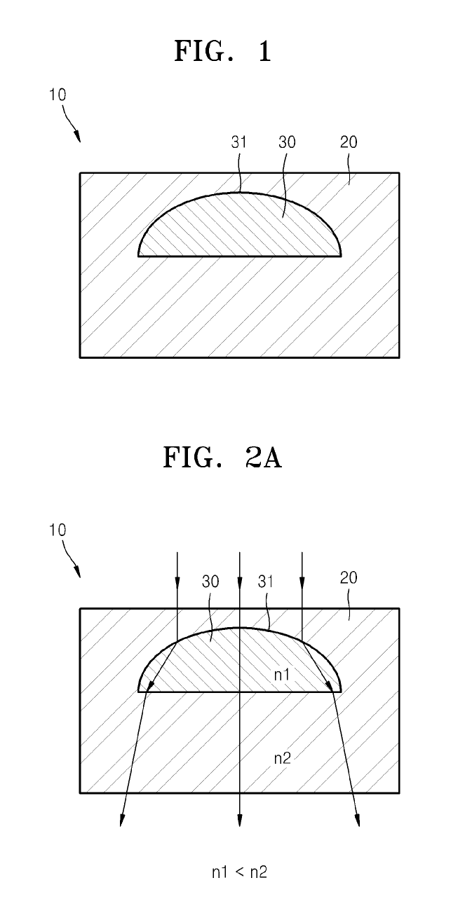

FIG. 1 is a schematic diagram of a micro lens 10 according to example embodiments.

Referring to FIG. 1, the micro lens 10 may include a substrate 20, and an internal lens region 30 existing in the substrate 20. Hereinafter, a region of the substrate 20 other than the internal lens region 30 is referred to as a substrate region 20, and denoted by the same reference numeral as the substrate 20, for convenience of description. The internal lens region 30 exists in the substrate 20, and may be formed to have a refractive index different from that of the substrate 20 and have at least one boundary contacting the substrate 20 to be formed as a curve 31. Light incident in the substrate 20 through a surface of the substrate 20 may be converged or diverged at the curve 31.

The substrate 20 may have a structure in which there is at least one flat surface. As an example, FIG. 1 shows that upper and lower surfaces of the substrate 20 are flat. The upper surface of the substrate 20 may be a light incident surface, and the lower surface of the substrate 20 may be a light exit surface. On the other hand, the lower surface of the substrate 20 may be the light incident surface, and the upper surface of the substrate 20 may be the light exit surface. Another structure, such as a diffractive element, may be further formed on a surface of the substrate 20.

The substrate 20 may be formed of, for example, a semiconductor substrate. The micro lens 10 having a structure in which the internal lens region 30 is included in the substrate 20 may be formed by performing an ion implantation to form the internal lens region 30 in the substrate 20 or performing an ion implantation of the region other than the internal lens region 30 of the substrate 20, so that the substrate region 20 and the internal lens region 30 may have refractive indexes different from each other.

The substrate 20 may be a silicon substrate. When the substrate 20 is a silicon substrate, the internal lens region 30 may include silicon oxide. Alternatively, the substrate 20 may be formed of silicon oxide, while the internal lens region 30 is formed of a silicon material.

For example, the substrate 20 may be the silicon substrate, and the internal lens region 30 formed of silicon oxide may be formed in the substrate 20 through an ion implantation. Otherwise, the region of the silicon substrate 20 other than the internal lens region 30, that is, the substrate region 20 is formed of silicon oxide through an ion implantation, and thus the substrate region 20 may be overall formed of silicon oxide and the internal lens region 30 may be formed of a silicon material.

For example, the refractive index of the silicon oxide region may be about 1.5 and the refractive index of the silicon region is about 3.5, at a wavelength of about 1.55 μm.

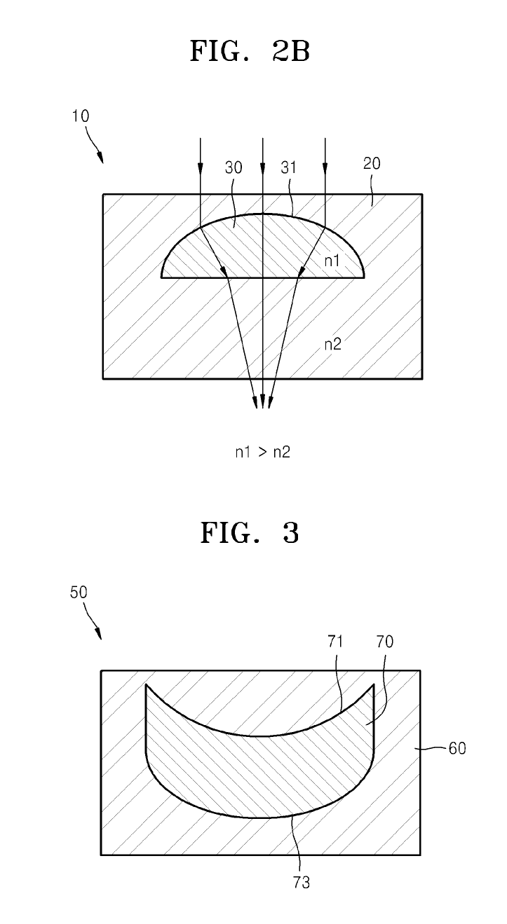

Therefore, when the substrate region 20 is formed of silicon, the internal lens region 30 is formed of silicon oxide, and the internal lens region 30 has a plano-convex lens shape, in which the convex curve 31 is formed on the light incident side, the internal lens region 30 has a refractive index that is less than that of the substrate region 20. Thus, when parallel light is incident in the substrate 20, the incident parallel light is refracted at the convex curve 31, that is, a boundary between the internal lens region 30 and the substrate region 20, and diverged, as shown in FIG. 2A. That is, although the internal lens region 30 has the plano-convex lens shape having the convex curve 31 at the light incident side, the internal lens region 30 may function as a concave lens for diverging the incident parallel light due to the refractive index of the internal lens region 30 being less than that of the peripheral portion.

On the other hand, when the internal lens region 30 is formed of a silicon material, the substrate region 20 is formed of silicon oxide, and the internal lens region 30 has a plano-convex lens shape having a convex curve at the light incident side through the ion implantation of the region of the substrate 20 other than the internal lens region 30 (the substrate region 20), the internal lens region 30 has a refractive index that is greater than that of the substrate region 20. Thus, when parallel light is incident in the substrate 20, the incident parallel light is refracted at the convex curve 31, that is, a boundary between the internal lens region 30 and the substrate region 20, and converged, as shown in FIG. 2B. That is, since the internal lens region 30 is formed as the plano-convex lens shape having the convex curve 31 at the light incident side and has a refractive index greater than that of the peripheral portion, the internal lens region 30 may function as a convex lens that converges the incident parallel light.

In the flat plate type micro lens 10 shown in FIG. 1, when it is assumed that the refractive index of the internal lens region 30 is n1, the refractive index of the substrate region 20 is n2, and the internal lens region 30 is formed as a plano-convex lens having a convex curve at the light incident side, the internal lens region 30 functions as a concave lens for diverging incident parallel light when n1<n2, as shown in FIG. 2A, and functions as a convex lens for converging incident parallel light when n1>n2, as shown in FIG. 2B.

FIG. 3 is a diagram showing a micro lens 50 according to example embodiments. As shown in FIG. 3, an internal lens region 70 may have a concave curve 71 at a light incident side. As an example, FIG. 3 shows that the internal lens region 70 is formed as a meniscus lens having the concave curve 71 at the light incident side and a convex curve 73 at a light exit side. In this case, the micro lens 50 may also function as a convex lens for converging incident parallel light or a concave lens for diverging incident parallel light according to a relation between refractive indexes of the internal lens region 70 and a substrate region 60.

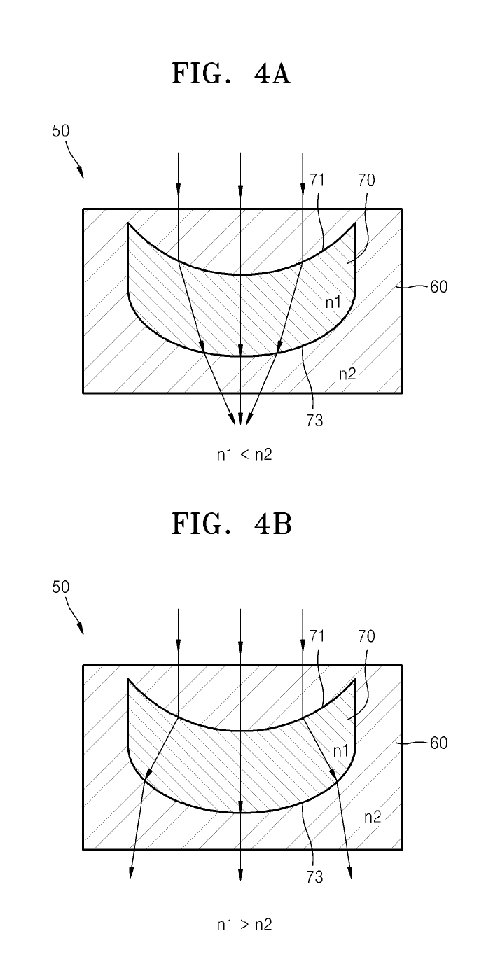

In a non-limiting embodiment, when a substrate 60 is formed of silicon, the internal lens region 70 is formed of silicon oxide, and the internal lens region 70 has a meniscus lens shape having the concave curve 71 at the light incident side, the internal lens region 70 has a refractive index less than that of the substrate region 60. Thus, when parallel light is incident in the substrate 60, the incident parallel light is refracted at the concave curve 71, that is, a boundary between the internal lens region 70 and the substrate region 60, and converged, as shown in FIG. 4A. That is, since the internal lens region 70 has a refractive index that is less than that of the peripheral portion, although the internal lens region 70 is formed as a meniscus lens having the concave curve 71 at the light incident side, if the refractive index of the internal lens region 70 is n1, the refractive index of the substrate region 60 is n2, and n1<n2, the internal lens region 70 functions as a convex lens for converging the incident parallel light.

On the other hand, when the internal lens region 70 is formed of a silicon material, the substrate region 60 is formed of silicon oxide through an the ion implantation of a region of the silicon substrate 60 other than the internal lens region 70 (the substrate region 60), and the internal lens region 70 is formed as a meniscus lens having the concave curve 71 at the light incident side, the internal lens region 70 has a refractive index that is greater than that of the substrate region 60. Therefore, when parallel light is incident in the substrate 60, the incident parallel light is refracted at the concave curve 71, that is, a boundary between the internal lens region 70 and the substrate 60, and diverged, as shown in FIG. 4B. That is, although the internal lens region 70 is formed as a meniscus lens having the concave curve 71 at the light incident side, the refractive index of the internal lens region 70 is greater than that of the peripheral region, that is, when the refractive index of the internal lens region 70 is n1, the refractive index of the substrate region 60 is n2, and n1>n2, the internal lens region 70 functions as a concave lens for diverging the incident parallel light.

As described above, by performing the ion implantation in the flat substrate 20 or 60, the internal lens region 30 or 70 and the substrate region 20 or 60 have refractive indexes different from each other, and at least one boundary between the internal lens region 30 or 70 and the substrate region 20 or 60 is formed to be a convex or concave curve. Therefore, the micro lens 10 or 50 functioning as a convex lens or a concave lens may be realized.

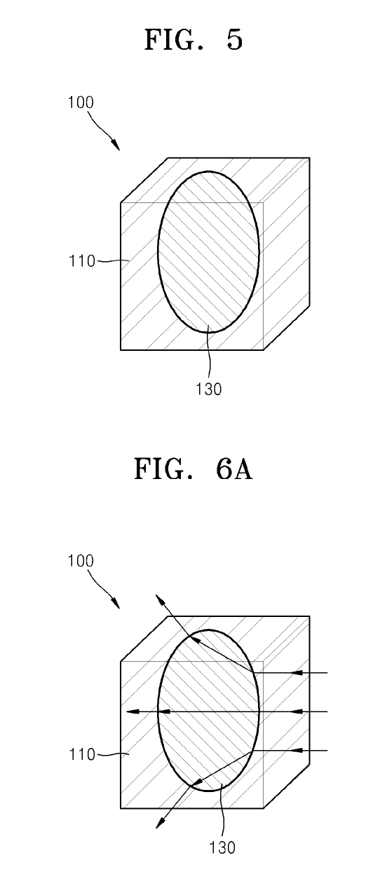

FIG. 5 is a schematic diagram of a micro lens 100 according to example embodiments.

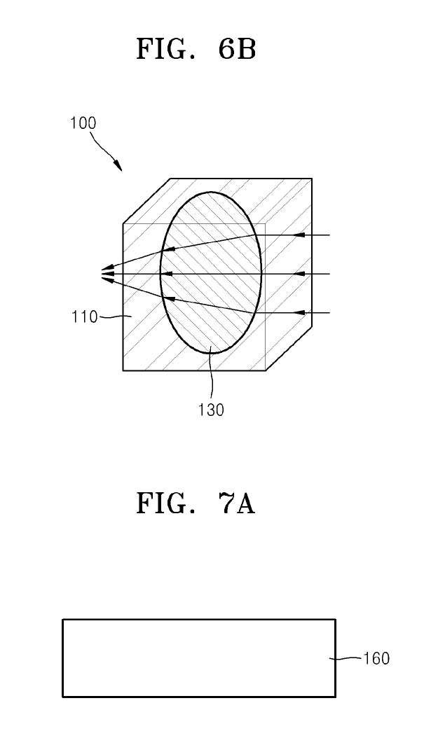

Referring to FIG. 5, the micro lens 100 may have a structure in which an internal lens region 130 is formed as a vertical lens in a flat substrate 110. That is, light incident/exit surfaces are side surfaces of the substrate 110, not upper and lower surfaces of the substrate 110, and parallel light incident through a side surface may be diverged or converged, as shown in FIGS. 6A and 6B.

FIG. 5 shows an example in which the internal lens region 130 is formed as a bi-convex lens having convex surfaces as boundaries between the internal lens region 130 and a substrate region 110. As described above, even when the internal lens region 130 is formed as a convex lens, if the internal lens region 130 has a refractive index that is less than that of the substrate region 110, incident parallel light is diverged, as shown in FIG. 6A, and the micro lens 100 functions as a concave lens. If the internal lens region 130 has a refractive index that is greater than that of the substrate region 110, incident parallel light is converged, as shown in FIG. 6B, and the micro lens 100 functions as a convex lens.

When the following conditions are satisfied, a lens may be formed in a substrate. As will be described throughout the following description, the micro lens 10, 50, or 100 may be manufactured according to example embodiments.

In order to form a lens in a substrate, implantation of materials having different refractive indexes, arrangement adjusting of the implantation materials through a two-dimensional pattern on a surface of the substrate by using a photomask, locating the implantation materials at different depths in the substrate in a vertical direction by using different implantation energies, and forming a region where the implantation material has a relatively rare defect through a thermal activation may need to be performed.

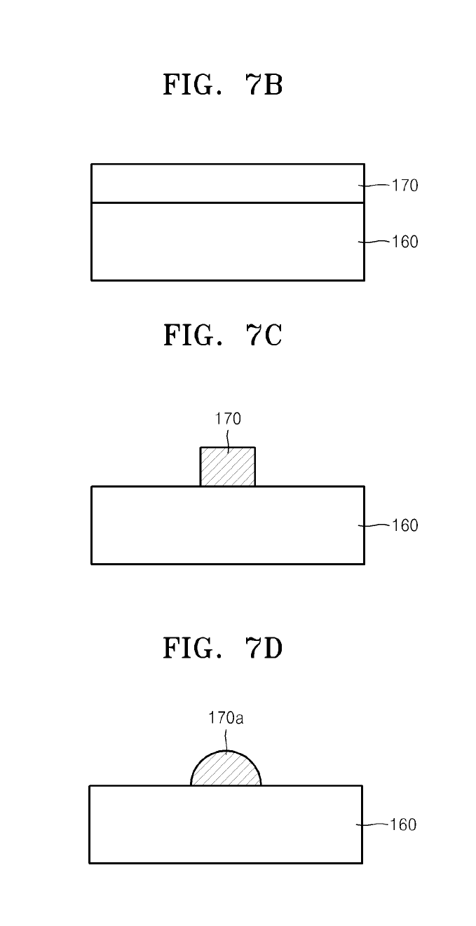

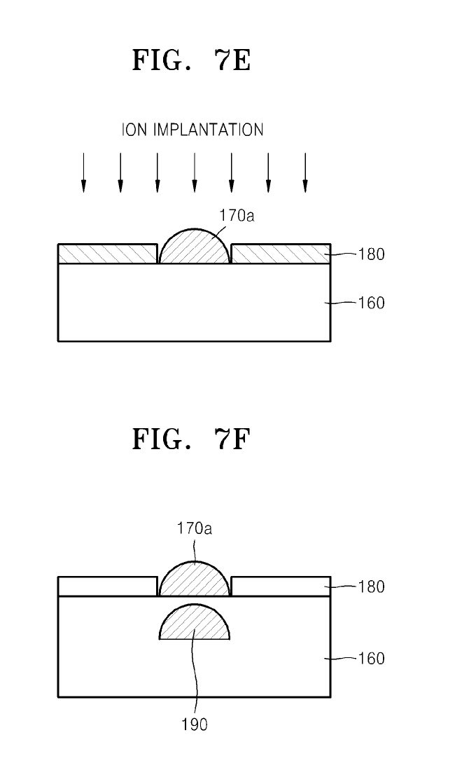

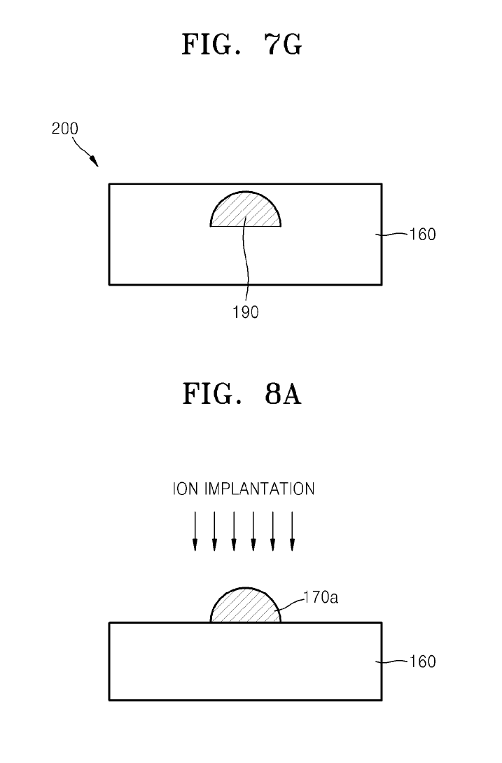

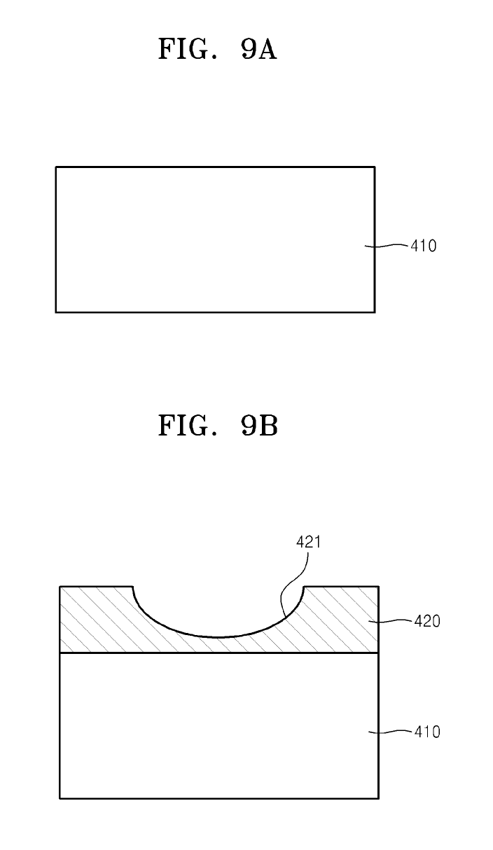

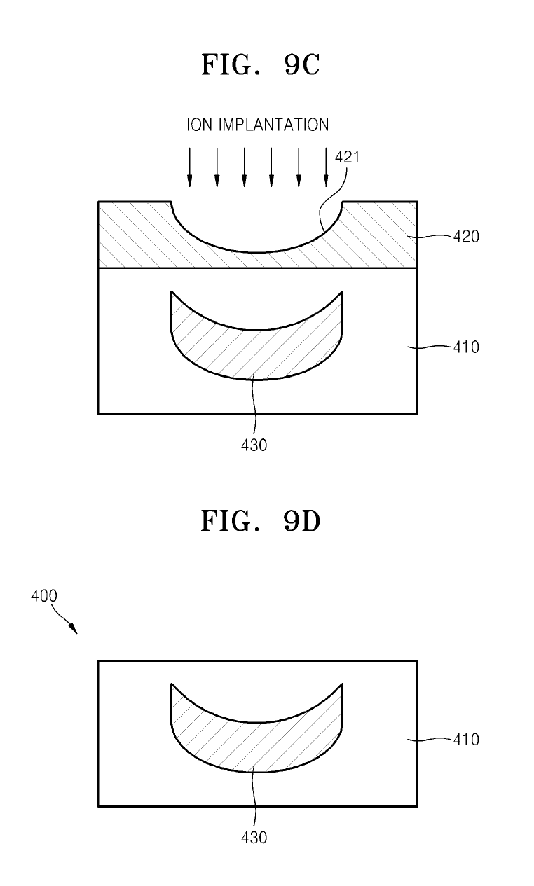

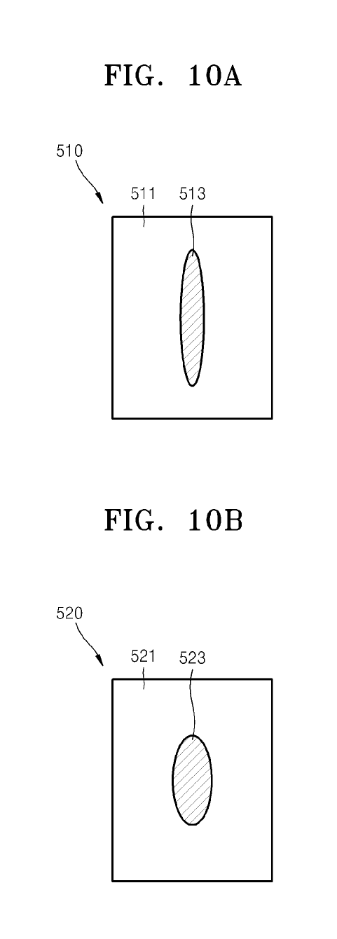

To manufacture the micro lens 10 and 50, that is, horizontal lenses, shown in FIGS. 1 and 3, after applying a photoresist for having a shape of a micro lens and used frequently in a charge coupled device (CCD) or a CMOS image sensor (CIS) and performing an etch-back of the photoresist to form a micro lens hard mask (refer to 170a and 180 of FIGS. 7E and 420 of FIG. 9C, which will be described later), an implantation process is performed. A region having different refractive indexes may be formed in the substrate, as shown in FIGS. 1 and 3.

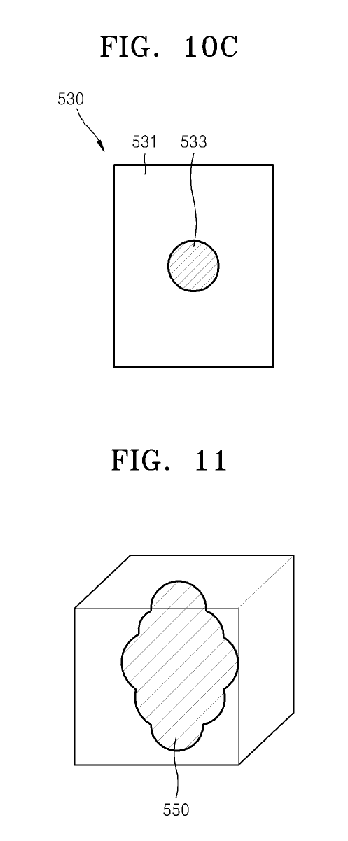

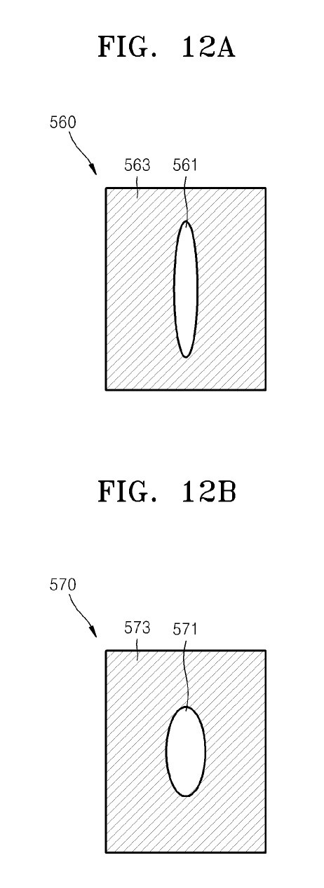

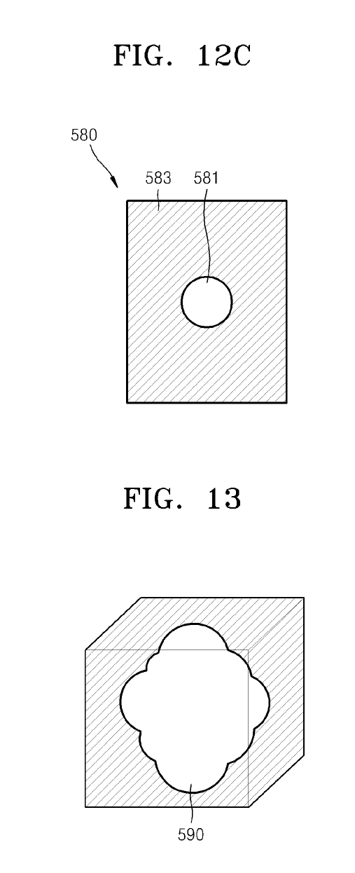

In order to manufacture the micro lens 100 shown in FIG. 5, that is, vertical lenses, a two-dimensional pattern is formed on a substrate, and then different implantation energies in a depth direction may be used, as shown in FIGS. 10A through 10C and FIGS. 12A through 12C, which will be described later. In this case, a three-dimensional lens, as shown in FIGS. 11 and 13, may be formed, and a lens surface may be rough, not smooth, as shown in FIG. 5, due to variation of the implantation ion in a side direction and a vertical direction. The surface roughness may be smoothed during a thermal activation process.

Hereinafter, a method of manufacturing the micro lens 10, 50, or 100 according to example embodiments will be described with reference to accompanying drawings.

FIGS. 7A through 7G are diagrams illustrating a method of manufacturing a micro lens according to example embodiments.

Referring to FIG. 7A, a substrate 160 is prepared. The substrate 160 may be formed of, for example, silicon.

Next, as shown in FIG. 7B, a pattern material layer 170 is applied on the substrate 160. A material that is reflowed by heat may be used to form the pattern material layer 170. For example, the pattern material layer 170 may be a photoresist.

Next, as shown in FIG. 7C, the pattern material layer 170 is patterned such that the pattern material layer 170 remains on a portion corresponding to a location where an internal lens region will be formed. The pattern material layer 170 may be patterned to have a width that corresponds to the internal lens region that will be formed. A thermal reflow process is performed with respect to the pattern material layer 170 patterned to a desired or predetermined width so as to form a pattern portion 170a, as shown in FIG. 7D. The pattern portion 170a may be formed as a hemisphere; however, it should be understood that example embodiments are not limited thereto.

Next, as shown in FIG. 7E, ions are implanted in the substrate 160 through the pattern portion 170a. Here, the ion implantation may be performed by using a mask 180 having an opening that corresponds to the pattern portion 170a.

As described above, when the ions are implanted in the substrate 160 through the pattern portion 170a by using the mask 180 having the opening that corresponds to the pattern portion 170a while adjusting an ion implantation energy, an internal lens region 190 having a shape corresponding to the pattern portion 170a may be formed in the substrate 160, as shown in FIG. 7F. The internal lens region 190 has a refractive index that is less than that of the material forming the substrate 160. For example, when the substrate 160 is formed of silicon, oxygen ions may be implanted so as for the internal lens region 190 to be formed of silicon oxide. As described above, at a certain wavelength band, the refractive index of the silicon oxide is much less than the refractive index of the silicon.

Next, the pattern portion 170a and the mask 180 are removed, and an annealing process is performed. Then, a micro lens 200 having the internal lens region 190 is manufactured, as shown in FIG. 7G. Through the processes shown in FIGS. 7A through 7G, the micro lens 10 shown in FIG. 2A having a structure in which ions are implanted in the internal lens region 30 may be fabricated.

The micro lens 10 in which the ions are implanted in the substrate region 20, as shown in FIG. 2B, may be manufactured through following processes.

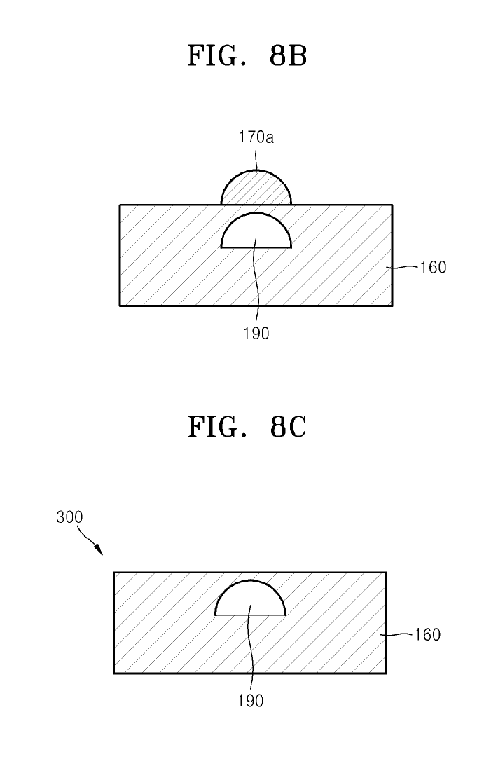

In a state where the pattern portion 170a is formed on the substrate 160 through the processes shown in FIGS. 7A through 7D, ions are implanted in the substrate 160 through the pattern portion 170a, as shown in FIG. 8A. Here, if only the pattern portion 170a is existed on the substrate 160, as shown in FIG. 8A, when the ions are implanted in the substrate 160 while adjusting the ion implantation energy, the pattern portion 170a functions as a mask, and the ions are implanted in the entire substrate 160, except for a region corresponding to the pattern portion 170a. Thus, the internal lens region 190 having a shape corresponding to the pattern portion 170a is formed in the substrate 160, as shown in FIG. 8B. Here, since the ions are not implanted in the internal lens region 190, the refractive index of the internal lens region 190 is the same as that of the substrate material before the ion implantation. In addition, the substrate region 160 has a refractive index that is less than that of the internal lens region 190. For example, if the substrate 160 is formed of silicon, oxygen ions may be implanted so that the internal lens region 190 may be formed of silicon and the substrate region 160 may be formed of silicon oxide.

Next, the pattern portion 170a is removed, and an annealing process is performed. Then, a micro lens 300 in which the ions are implanted in the substrate region 160, but not in the internal lens region 190, may be formed, as shown in FIG. 8C. Through the processes shown in FIGS. 7A through 7D, and FIGS. 8A through 8C, the micro lens 10 in which the ions are implanted in the region of the substrate 60 other than the internal lens region 30, as shown in FIG. 2B, may be manufactured.

FIGS. 9A through 9E are diagrams showing processes of manufacturing a micro lens having an internal lens region having a concave curve at a light incident side.

Referring to FIG. 9A, a substrate 410 is prepared. The substrate 410 may be formed of, for example, silicon.

Next, as shown in FIG. 9B, a mask layer 420 having a concave curve 421 is formed on the substrate 410.

As shown in FIG. 9C, ions are implanted in the substrate 410 through the mask layer 420. Here, since the mask layer 420 has a thickness that is thinner at a portion where the concave curve 421 is formed than at other portions, when the ions are implanted in the substrate 410 while adjusting an ion implantation energy, the ions are implanted in a region in the substrate 410 that corresponds to the concave curve 421. Thus, as shown in FIG. 9D, an internal lens region 430 having a shape corresponding to the concave curve 421 and a desired or predetermined thickness is formed in the substrate 410. The internal lens region 430 may be formed as a meniscus lens. The internal lens region 430 has a less refractive index less than that of the substrate 410. For example, when the substrate 410 is formed of silicon, oxygen ions may be implanted so that the internal lens region 430 may be formed of silicon oxide.

Next, the mask layer 420 is removed, and an annealing process is performed. Then, a micro lens 400 having the internal lens region 430, as shown in FIG. 9D, is manufactured. Through the processes shown in FIGS. 9A through 9D, the micro lens 50 having the internal lens region 70 formed as a meniscus lens, as shown in FIG. 3, may be fabricated.

FIGS. 10A through 10C are diagrams showing examples of a mask that is used to form the vertical lens structure shown in FIG. 6A. As shown in FIGS. 10A through 10C, ions may be implanted through an oval shaped ion implantation portion 513, 523, or 533 having a varied ratio between the major axis and the minor axis. In addition, an implantation depth is adjusted while varying the implantation energy in a depth direction by using a mask 510, 520, or 530 having a shielding portion 511, 521, or 531, and then an internal lens region 550 formed as a vertical lens having a three-dimensional structure may be formed, as shown in FIG. 11. Here, a surface of the internal lens region 550 may be rough due to the variation of the implantation ion in a side direction and the vertical direction as shown in FIG. 11. The rough surface may be smoothed through a thermal activation process. Thus, the vertical lens having a smooth surface and in which the internal lens region 130 has a refractive index less than that of the substrate region 110 may be formed, as shown in FIG. 6A.

FIGS. 12A through 12C are diagrams showing other examples of a mask that is used to form the vertical lens structure shown in FIG. 6B. As shown in FIGS. 12A through 12C, a mask 560, 570, or 580 having an oval shaped shielding portion 561, 571, or 581 having a varied ratio between the major axis and the minor axis and a peripheral portion 563, 573, or 583, through which ion implantation may be performed, is used, and an implantation depth is adjusted while varying an implantation energy in a depth direction. Then, as shown in FIG. 13, an internal lens region 590 formed as a vertical lens having a three-dimensional structure may be formed. Here, a surface of the internal lens region 590 may be rough due to the variation of the implantation ion in a side direction and the vertical direction, as shown in FIG. 13. The rough surface may be smoothed through a thermal activation process. Thus, the vertical lens having a smooth surface and in which the substrate region 110 has a refractive index less than that of the internal lens region 130 may be formed, as shown in FIG. 6B.

According to the micro lenses of example embodiments, an internal lens region is included in a flat substrate, and thus a micro lens may be applied to various fields such as an optical interconnect and silicon photonics requiring the micro lens to accurately control light beams. In addition, light converging/diverging may be relatively easily performed in a substrate with a reduced size, and a photo-coupling efficiency may be improved.

For example, in a case of a micro lens of the horizontal lens type described with reference to FIGS. 1 through 4B, when an external light source is coupled to an optical interconnection chip, a light beam may be converged, thereby increasing a coupling efficiency. In addition, when the light beam is coupled to outside, a collimated light beam may be transmitted. Here, since an external lens is not used, processes may be performed more simply without surface roughness, and chip contact may be performed relatively easily. In addition, since a photonic integration may be formed as a chip, a three-dimensional integration may be relatively easily performed. Also, light emitted from a light emitting diode (LED) may be converged, and thus a collimated light source may be formed.

For example, in a case of a micro lens of the vertical lens type described with reference to FIGS. 5 through 6B, between chips for optical interconnect, optical fibers or waveguides having refractive index different from a chip substrate (for example, SiN, SiO₂, etc.) are connected to transmit optical signals. Here, the optical fibers, the SiN waveguide, or the SiO₂ waveguide has a refractive index less than that of a silicon waveguide that is frequently used in the substrate, and thus there is a large difference between mode sizes and an external lens is necessary for photo-coupling of a high efficiency. However, when an external lens is used, it is relatively difficult to obtain a high coupling efficiency due to a large difference between numerical apertures. The micro lenses according to example embodiments are an internal lens type having an internal lens region in a flat substrate, and thus the micro lenses of the internal lens type may be located in a chip and a mode size conversion may be performed effectively. Therefore, according to the micro lenses of example embodiments, a mode converter may not be used or the micro lenses may be combined with a mode converter, thereby improving the coupling efficiency.

The micro lenses according to example embodiments may be applied to an optical apparatus. That is, the optical apparatus may include the micro lenses according to example embodiments and an optical device receiving light converged or diverged by the micro lenses. Here, the optical device may be one of a photodetector, an image sensor, an optical fiber, and an optical waveguide for an optical integration circuit.

According to the micro lens of example embodiments, the micro lens has the internal lens region that has a different refractive index from that of a substrate and has a convex or concave curve at least one boundary between the internal lens region and the substrate, in the substrate having at least one flat surface. Thus, when the micro lens may be applied to various optical technologies, the optical coupling efficiency may be improved greatly.

It should be understood that example embodiments described therein should be considered in a descriptive sense only and not for purposes of limitation. Descriptions of features or aspects within each embodiment should typically be considered as available for other similar features or aspects in other embodiments.

What is claimed is:

1. A micro lens comprising:
a substrate; and
an internal lens region within the substrate, the internal lens region having a first refractive index that is different from a second refractive index of the substrate, the internal lens region including at least one boundary contacting the substrate, the at least one boundary having a form of a curve,
wherein the micro lens is configured such that incident light entering the substrate through a surface of the substrate is converged or diverged by the curve.

2. The micro lens of claim 1, wherein the substrate has at least one flat surface.

3. The micro lens of claim 1, wherein the first refractive index of the internal lens region is less than the second refractive index of the substrate.

4. The micro lens of claim 3, wherein the substrate includes silicon, and the internal lens region includes silicon oxide.

5. The micro lens of claim 4, wherein the internal lens region is formed in the substrate by an ion implantation.

6. The micro lens of claim 3, wherein the internal lens region is formed in the substrate by an ion implantation.

7. The micro lens of claim 1, wherein the second refractive index of the substrate is less than the first refractive index of the internal lens region.

8. The micro lens of claim 7, wherein the substrate includes silicon oxide, and the internal lens region includes silicon.

9. The micro lens of claim 8, wherein the substrate is obtained by performing an ion implantation of a silicon layer and not subjecting a region of the silicon layer corresponding to the internal lens region to the ion implantation.

10. The micro lens of claim 7, wherein the substrate is obtained by performing an ion implantation of a layer and not subjecting a region of the layer corresponding to the internal lens region to the ion implantation.

11. The micro lens of claim 1, wherein the substrate is a silicon substrate.

12. The micro lens of claim 1, wherein the substrate is a semiconductor substrate.

13. The micro lens of claim 1, wherein the substrate and internal lens region include a same base material.

14. The micro lens of claim 1, wherein one of the substrate and internal lens region includes an element not present in the other of the substrate and internal lens region.

15. The micro lens of claim 14, wherein the element is oxygen.

16. The micro lens of claim 1, wherein the internal lens region has a meniscus shape.

17. The micro lens of claim 1, wherein the internal lens region has a partial ellipsoidal or a partial spherical shape.

18. An optical apparatus comprising:
the micro lens of claim 1; and
an optical device configured to receive light that is converged or diverged by the micro lens.

19. The optical apparatus of claim 18, wherein the micro lens is formed of a silicon material.

20. The optical apparatus of claim 18, wherein the optical device is one selected from the group consisting of a photodetector, an image sensor, an optical fiber, and an optical waveguide for an optical integration circuit.

21. A method of forming a micro lens, the method comprising:
preparing a substrate; and
performing an ion implantation on the substrate to define an internal lens region and a substrate region within the substrate, only one of the internal lens region and the substrate region being subjected to the ion implantation so as to form an ion-implanted region, the internal lens region having a first refractive index and the substrate region having a different second refractive index as a result of the ion implantation, at least one boundary between the substrate region and the internal lens region being in a form of a curve.

22. The method of claim 21, wherein the internal lens region is subjected to the ion-implantation such that the first refractive index is less than the second refractive index of the substrate region.

23. The method of claim 21, wherein the substrate region is subjected to the ion-implantation such that the second refractive index of the substrate region is less than the first refractive index of the internal lens region.

24. The method of claim 21, wherein the substrate includes silicon.

25. The method of claim 24, wherein the ion-implanted region of the substrate includes silicon oxide.
